(19) United States
(12) Patent Application Publication
(10) Pub. No.: US 2011/0045843 A1
(43) Pub. Date: Feb. 24, 2011

(54) System and method for mobile group positioning

(76) Inventors: Chin-Iin Hu, Taipei City (TW); Chien-An Cho, Taipei City (TW); Chen-Wei Fan, Zhonghe City (TW); Chang-Jung Lin, Xinzhuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/654,050

(22) Filed: Dec. 9, 2009

(30) Foreign Application Priority Data
Aug. 24, 2009 (TW) 098128438

(51) Int. Cl. H04W 4/02

(52) U.S. Cl. 455/456.1

(57) ABSTRACT

The present invention provides a system and a method for mobile group positioning, which are applied to a plurality of mobile devices of a group. The system comprises a central control unit, a plurality of mobile tracking units, and a plurality of mobile message units. The mobile tracking units and the mobile message units are disposed in the mobile devices. The mobile message units correspond to the mobile tracking units, respectively. The mobile message units add a user message to the corresponding positioning messages, respectively, and transmit to the central control unit. The central control unit transmits the positioning messages including the user message to the mobile message unit of one of the mobile devices in the group. Thereby, the mobile device need not consume extra network resources or power in transmitting the user messages, and hence achieving power-saving effect and saving network resources.

### FIELD OF THE INVENTION

The present invention relates to a system and a method for positioning, and particularly to a system and a method for mobile group positioning.

### BACKGROUND OF THE INVENTION

A next-generation mobile communication system will be presented in the form of mobile heterogeneous network. For mobile network data services, the major feature that the mobile communication system can provide an environment accessible by wireless heterogeneous network is providing users with ubiquitous data services so that they can connect to the Internet anytime anywhere via handheld communication devices (for example, various wireless mobile handheld devices (MHD) and portable information devices (PID) such as mobile phones, personal digital assistants, mobile network devices, and ultra mobile PCs (UMPCs)) without considering the network environment they are in or the transmission technology they should use. In addition, for information services, when the development of network communication systems becomes more integrated and mobile and wireless wideband networks can provide high-speed network data transmission, ubiquitous mobile and wireless Internet will be formed. Under such a circumstance, integrated mobile heterogeneous networks will provide a noble network application platform, which is beneficial for developing more new and potential information services.

In a network environment of mobile Internet, the consumer behavior of the users will not be limited by traditional telecommunication network operators for their value-added services, such as email, push to talk, conferencing, and group management, developed in multimedia sub-systems. Once the users can connect to the mobile Internet freely, they can enjoy application services other than the value-added services provided by traditional network operators. For them, they will have more choices for varied information content services. The value-added services provided by traditional telecommunication network operators are limited to their business models, so the services used by the users are constrained. Besides, the value-added services provided are closed and are designed according to the network specifications of their own. Thereby, the value-added services provided by different telecommunication operators are not interconnected. Currently, although Microsoft Corporation has developed an embedded operating system for mobile phones and set a milestone for mobile Internet, their systems still comply with the development direction of traditional telecommunication operators and are applied in the networks of different traditional telecommunication operators, respectively. Accordingly, Google developed a mobile platform and an embedded operating system with open architectures. Thereby, the users of mobile Internet can have more choices for mobile platforms and embedded operating systems. Besides, the multimedia services can thus have more variations.

Nevertheless, when the services are diversified, personalized user messages increase, which, in turn, increases power consumption of mobile devices and hence is unfavorable to battery life of the mobile devices. Additionally, current mobile devices with multimedia services generally have a mobile positioning function. Thereby, they transmit positioning messages to servers, such as the guide server in an exhibition hall, regularly or irregularly for acquiring position-dependent guiding information. For mobile devices transmitting user messages as well as positioning messages, loading in network resources and power consumption can thus increase. Moreover, for people engaged in outdoor group activities, such as mountain climbing or exhibition shows, users of mobile devices will build peer groups for acquiring positioning messages of others at any time for confirming safety. However, the users cannot control the groups effectively, which is very inconvenient for group message security. Thereby, message security is one of the major concerns for developing peer groups.

Accordingly, the present invention provides a system and a method for mobile group positioning for solving the problems described above. The system and method for mobile group positioning according to the present invention provides better power-saving efficiency at better transmission rate with better message security. Thus, the problems described above can be solved.

### SUMMARY

An objective of the present invention is to provide a system and a method for mobile group positioning, which add user message to positioning message for reducing network resources used by mobile devices.

Another objective of the present invention is to provide a system and a method for mobile group positioning, which add user message to positioning reply message for reducing network resources used by servers.

Still another objective of the present invention is to provide a system and a method for mobile group positioning, which add user message to positioning message and transmit them altogether for reducing power consumed by user messages and thus providing better power-saving efficiency.

A further objective of the present invention is to provide a system and a method for mobile group positioning, which uses a central control unit as the third-party control group for providing better information security.

The present invention provides a system for mobile group positioning, which is applied to a group of a plurality of mobile devices. The system comprises a central control unit, a plurality of mobile tracking units, and a plurality of mobile message units. The plurality of mobile tracking units and the plurality of mobile message units are disposed in the plurality of mobile devices, respectively. The mobile tracking units produce positioning output messages according to their own geographical locations and transmit the messages to the central control unit. The central control unit forwards the positioning output message to the mobile message units of other mobile devices when it receives the message. The plurality of mobile message units corresponds to the plurality of mobile tracking units, respectively, and is used for adding a user message to the positioning message, respectively, and transmitting the message to the central control unit. The central control unit transmits the positioning message including the user message to the mobile message unit of one of the mobile devices of the group for transmitting the user message to an appointed receiving mobile message unit of the group. In addition, when the mobile message unit transmits the positioning message including the user message to the mobile message unit of one of the mobile devices of the group, the positioning message including the user message is encrypted before transmission.

In order to make the structure and characteristics as well as the effectiveness of the present invention to be further understood and recognized, the detailed description of the present invention is provided as follows along with embodiments and accompanying figures.

### BRIEF DESCRIPTION OF THE DRAWINGS

FIG. 1 shows a block diagram according to a preferred embodiment of the present invention;

FIG. 2 shows a flowchart for group building according to an embodiment of the present invention;

FIG. 3 shows a flowchart for group joining according to an embodiment of the present invention;

FIG. 4 shows a flowchart of unicast message delivery mode according to an embodiment of the present invention;

FIG. 5 shows a flowchart of multicast message delivery mode according to an embodiment of the present invention;

FIG. 6 shows a flowchart of zone message delivery mode according to an embodiment of the present invention;

FIG. 7 shows a flowchart of the process at the managerial terminal according to an embodiment of the present invention; and

FIG. 8 shows a flowchart of the process at the managerial terminal according to another embodiment of the present invention.

### DETAILED DESCRIPTION

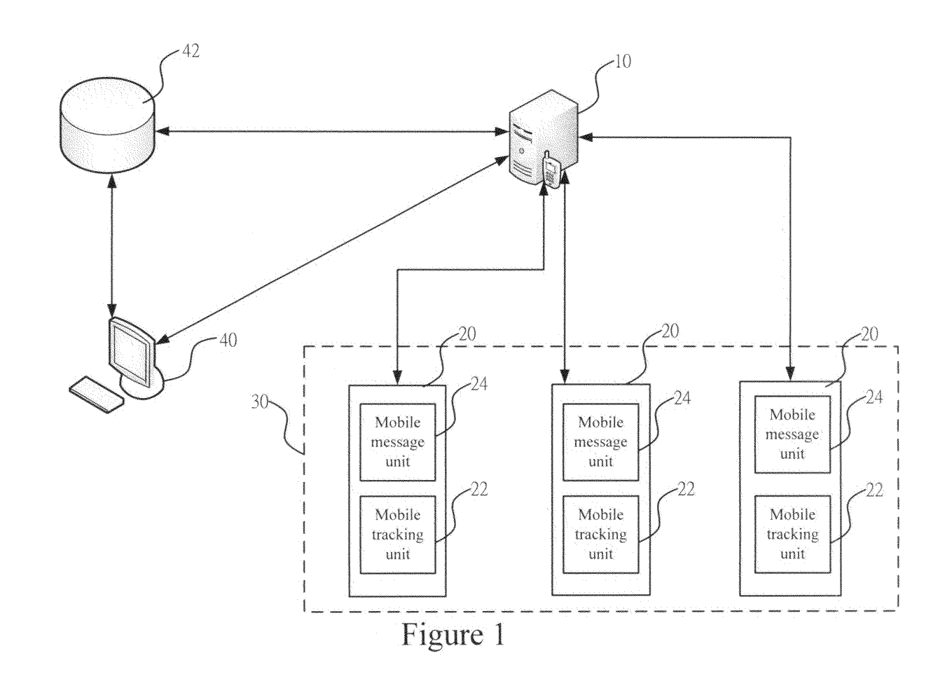

FIG. 1 shows a block diagram according to a preferred embodiment of the present invention. As shown in the figure, the present invention provides a system for mobile group positioning, which is applied to a group 30 comprised by a plurality of mobile devices 20. The system according to the present invention comprises a central control unit 10, a plurality of mobile tracking units 22, and a plurality of mobile message units 24. The central control unit 10 connects the plurality of mobile devices 20. The plurality of mobile tracking units 22 and the plurality of mobile message units 24 are disposed in the plurality of mobile devices 20, respectively. The plurality of mobile tracking units 24 produces a positioning message according to the geographical location of the plurality of mobile devices 20 and transmits the message to the central control unit 10. When one of the mobile message units 24 transmits a user message to at least an appointed receiving mobile message unit 24, the mobile message unit 24 adds the user message to the positioning message corresponding to the mobile tracking unit 22 and transmits the message to the central control unit 10. The central control unit 10 transmits the positioning message including the user message to the mobile message unit 24 of one of the mobile devices 20 of the group 30, which then judges if the user message is valid. If the mobile message unit 24 confirms validity of the user message, it reads the user message. Besides, when the central control unit 10 transmits the positioning message to the mobile message units 24 of the other mobile devices 20 of the group 30, a fake positioning message is further transmitted for enhancing message privacy. The mobile tracking units 22 of the mobile devices 20 can differentiate between the received positioning messages and fake positioning messages according to positioning history information, which includes at least the positioning message received last time by the mobile tracking unit 22.

Before one of the mobile devices 20 builds the group 30, the mobile device 20 to build the group 30 produces a group-building message to the central control unit 10 in terms of the mobile message unit 24. The central control unit 10 builds the group 30 according to the group-building message and produces a group code. Before one of the mobile devices 20 joins the group 30, the mobile message unit 24 adds the group code produced by the central control unit 10 to the positioning message and transmits the message to the central control unit 10. When the central control unit 10 validates existence of the group according to the group code, it adds the mobile device 20 to the group 30 and transmits a corresponding system message to the mobile device 20. In addition, the mobile message unit 24 further encrypts messages to be transmitted to the central control unit 10 for transmitting encrypted messages to the central control unit 10. The central control unit 10 further encrypted messages to be transmitted to the mobile message units 24 for transmitting encrypted messages to a second mobile message unit 24.

The central control unit 10 is a server with a fixed network location. The user of the mobile device 20 can preset the central control unit 10 in the node list of the mobile device 20. When the mobile device 20 searches and gets the central control unit 10 on the network, it can connect with the central control unit 10 at any time for exchanging messages in the master-slave model. The central control unit 10 according to the present invention has the following four functions: 1. Status management of groups and peer group; 2. Management and tracking services of group location information; 3. Registering and resending services for group messages; and 4. Location information inquiry and message forwarding services within a group.

### 1. Status Management of Groups and Peer Group:

Regarding to status management of groups 30, a user can request the central control unit 10 for inquiring the group status, namely, inquiring the currently registered groups in the central control unit 10. If the central control unit 10 does not have the group record corresponding to the user, the user can apply to the central control unit 10 for building a group 30. After the central control unit 10 accepts the request, it performs attribute configuration, which includes member conditions of the group 30, and management for the group 30.

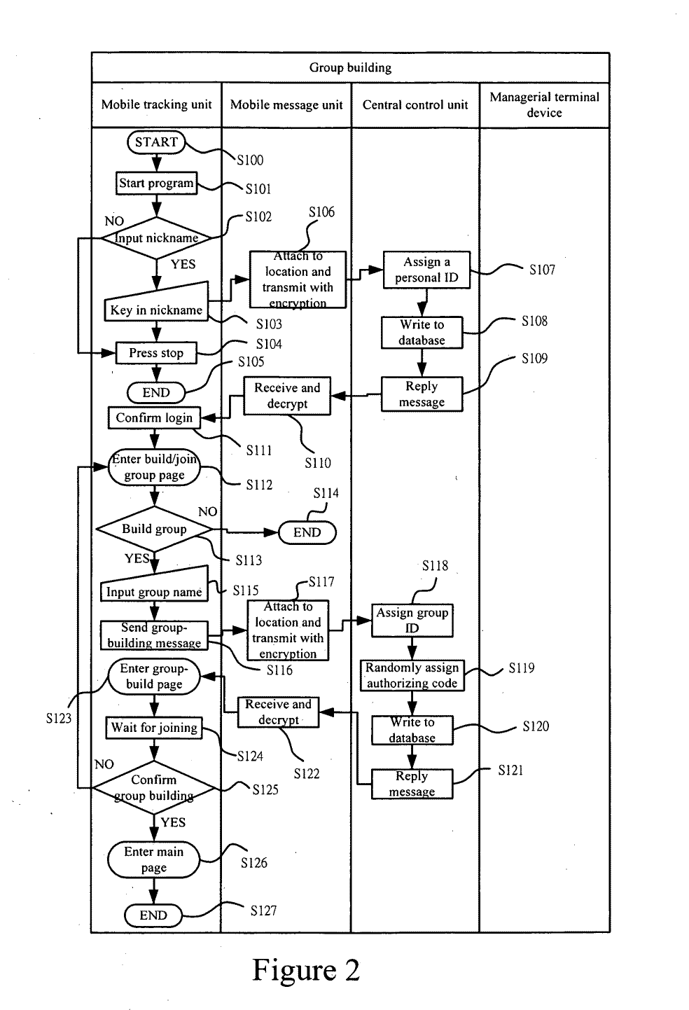

FIG. 2 shows a flowchart for group building according to an embodiment of the present invention. As shown in the figure, in the method for mobile group positioning according to the present invention, the procedure for group building is described as follows. Step S100: Start. Step S101: Start program, which means that the mobile tracking unit 22 executes the group-building program. Step S102: Input nickname, which judges if the user inputs a nickname. If yes, the, step S103 is executed, otherwise the step S104 is executed. Step 103: Key in a nickname, which means that the user keys in a nickname. Step S104: Press stop, which means that the user presses the stop key. Step S105: End. Step S106: Attach to location and transmit with encryption, which mean that the mobile message unit 24 adds the user message of the nickname to the positioning message, encrypts the message, and transmits to the central control unit 10. Step S107: Assign a personal ID, which means that the central control unit 10 assigns a corresponding ID. Step S108: Write to database, which means that the central control unit 10 writes the ID and the nickname to the database. Step S109: Reply message, which means that, according to the message of the step S106, the central control unit 10 transmits a reply message to the mobile message unit 24 that transmits message in the step S106. The central control unit 10 further encrypts the message to be transmitted to the mobile message unit 24 for transmitting it to the second mobile message unit 24. Step S110: Receive and decrypt, which mean that the mobile message unit 24 receives the replay message transmitted by the central control unit 10 in the step S109 and decrypts.

Step S111: Confirm login, which means that the user logins to the central control unit 10 according to the reply message. Step S112: Enter build/join group page, which means that the user operate the mobile tracking unit 22 to enter the build/join group page. Step S113: Judge if to build group. If not, the step S114 is executed; if yes, the step S115 is executed. Step S114: End. Step S115: Input group name, which means that the user operates the mobile tracking unit 22 to name a group and input a corresponding group name. Step S116: Send group-building message, which means that the mobile tracking unit 22 sends a group-building message including the group name. Step S117: Attach to location and transmit with encryption, which mean that the mobile message unit 24 which mean that the mobile message unit 24 adds the user message of the group-building message to the positioning message, encrypts the message, and transmits to the central control unit 10. Step S118: Assign a group ID, which means that the central control unit 10 assigns a group ID according to the group nickname. Step S119: Assign a 4-digit authorization code randomly. Step S120: Write to database, which means that the central control unit 10 writes the corresponding nickname and the group ID to the database. Step S121: Reply message, which means that, according to the message transmitted by the mobile message unit 24 in the step S117, the central control unit 10 transmits the reply message to the mobile message unit 24. Step S122: Receive and decrypt, which mean that the mobile message unit 24 receives the reply message transmitted by the central control unit 10. Step S123: Enter group-build page, which means that the user enters the group-building page. Step S124: Wait for joining, which means waiting for appearance of others. Step S125: Judge if group building is confirmed. If not, the step S112 is executed; if yes, the step S126 is executed. Step S126: Enter main page. Step S127: End.

If the central control unit 10 already has the record of the group 30, the user can apply for joining the group 30 to the central control unit 10. The central control unit 10 will perform identity check for the user according to the attribute configuration of the group 30 for verifying if the user complies with the attribute configuration of the group 30. If so, the central control unit 10 will add the mobile device 20 of the user to the group 30.

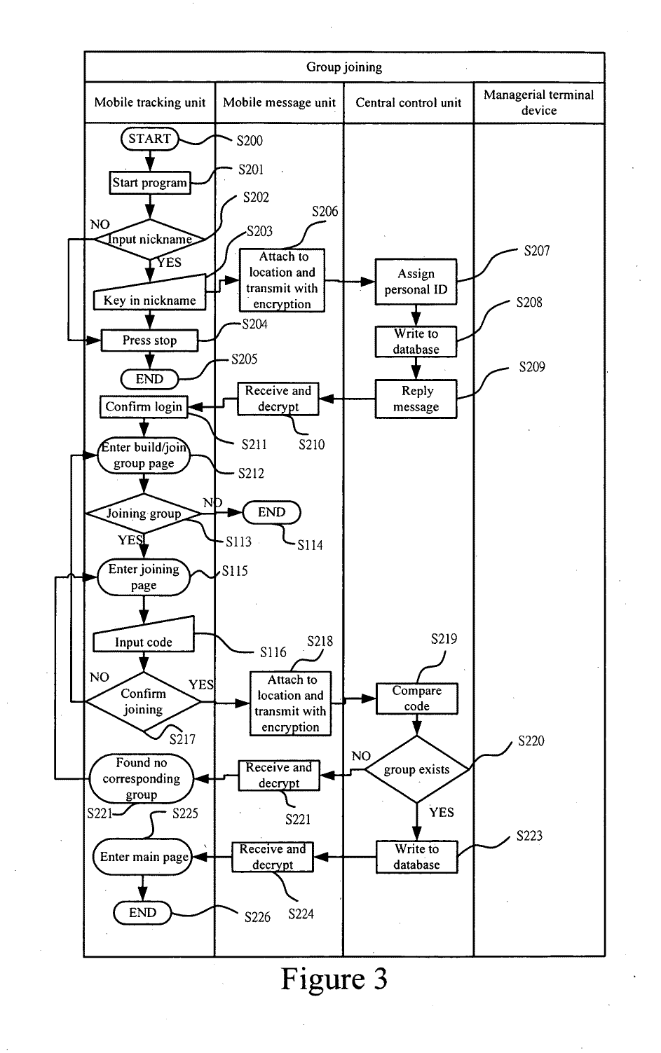

FIG. 3 shows a flowchart for group joining according to an embodiment of the present invention. As shown in the figure, in the method for mobile group joining according to the present invention, the procedure for group building is described as follows. Step S200: Start. Step S201: Start program, which means that the mobile tracking unit 22 executes the group joining program. Step S202: Input nickname, which judges if the user inputs a nickname. If yes, the step S203 is executed, otherwise the step S204 is executed. Step 203: Key in a nickname, which means that the user keys in a nickname. Step S204: Press stop, which means that the user presses the stop key. Step S205: End. Step S206: Attach to location and transmit with encryption, which mean that the mobile message unit 24 adds the user message of the nickname to the positioning message, encrypts the message, and transmits to the central control unit 10. Step S207: Assign a personal ID, which means that the central control unit 10 assigns a corresponding ID. Step S208: Write to database, which means that the central control unit 10 writes the ID and the nickname to the database. Step S209: Reply message, which means that, according to the message of the step S206, the central control unit 10 transmits a reply message to the mobile message unit 24 that transmits message in the step S206. The central control unit 10 further encrypts the message to be transmitted to the mobile message unit 24 for transmitting it to the second mobile message unit 24. Step S210: Receive and decrypt, which mean that the mobile message unit 24 receives the replay message transmitted by the central control unit 10 in the step S209 and decrypts.

Step S211: Confirm login, which means that the user logins to the central control unit 10 according to the reply message. Step S212: Enter build/join group page, which means that the user operate the mobile tracking unit 22 to enter the build/join group page. Step S213: Judge if to build group. If not, the step S214 is executed; if yes, the step S215 is executed. Step S214: End. Step S215: Enter joining page, which means that the user operates the mobile tracking unit 22 and enters the group-joining page. Step S216: Input 4-digit group code, which means that the user inputs the 4-digit group code to the mobile tracking unit 22. Step S217: Judge if joining is confirmed, which judges whether to join the group or not. If yes, the step S218 is executed; if not, the step S215 is executed. Step S218: Attach to location and transmit with encryption, which mean that the mobile message unit 24 attach a user message of group-joining message, which includes the nickname and the personal ID, to a positioning message, encrypts the message, and transmits to the central control unit 10. Step S219: Compare group code, which means that the central control unit 10 compares according to the 4-digit group code in the group-joining message. Step S220: Judge if the corresponding group code of the 4-digit group code exists or not, which means that the central control unit 10 judges according to the 4-digit group code. If not, the central control unit 10 transmits a joining failure message to the mobile message unit 24 for executing the step S221; if yes, the central control unit 10 executes the step S223, and further encrypts the message transmitted to the mobile message unit 24 for transmitting to the second mobile message unit 24. Step S221: Receive and decrypt, which mean that the mobile message unit 24 receives the joining failure message and decrypts the message for transmitting the joining failure message to the mobile tracking unit 22. Step S222: Found no corresponding group, which means that the mobile tracking unit 22 judges that central control unit 10 cannot find the corresponding group according to the joining failure message, and thereby the mobile tracking unit 22 executes the step S215 for returning to the group joining page. Step S223: Write to database, which means that the central control unit 10 judges existence of the corresponding group of the 4-digit group code, and thereby the central control unit 10 writes the nickname and the personal ID in the group joining message to the database 42, and transmits a reply message to the mobile message unit 24 according to the message sent by the mobile message unit 24 in the step S218. Step S224: Receive and decrypt, which mean that the mobile message unit 24 receives the reply message transmitted by the central unit 10 and decrypts the message. Step S225: Enter main page, which means that the mobile tracking unit 22 enters the main page according to the reply message. Step S226: End.

In addition, regarding to event notifications for joining, leaving, or dismissing the group 30, the central control unit 10 will notify instantaneously the mobile devices 20 used by the users in the group at that time. Meanwhile, the central control unit 10 will update the database, and users' mobile devices 20 can also update the record of the positioning messages of other mobile devices 20 corresponding to the same group 30. When the central control unit 10 transmitting the positioning messages to the mobile message units 24 of other mobile devices 20 in the group 30, at least a fake positioning message is further transmitted for increasing message privacy. The mobile tracking unit 22 of the mobile device 20 can differentiate between the positioning message and the fake positioning message received by the mobile device 20 according to positioning history data, which includes at least the positioning message received last time by the mobile tracking unit 22.

### 2. Management and Tracking Services of Group Location Information:

The central control unit 10 can track and record positioning continuously for the mobile device 20 of a single user or for the mobiles devices 20 in a single group 30. In addition to periodically inquiring the mobile devices 20 alternately by the central control unit 10 for continuous tracking and recording, the system can be further modified as spontaneous back reporting their own geographical locations by the mobile devices 20 to the central control unit 10, and thus reducing, the operation time for alternate inquiry. Moreover, the system can also be modified as back reporting the geographical location of a mobile device 20 to the central control unit 10 by another mobile device 20 cooperatively. Alternatively, the mobile device 20 can execute a piggyback mode for transmitting the geographical location to the central control unit 10. Besides, the central control unit 10 can further provide a management unit, which provides group management services, including tracking the mobile network nodes and locations of a specific group, and acquiring the movement information of the specific group in the mobile network nodes.

It is known from above that the mobile message unit 24 according to the present invention can use the piggyback mode provided by the central control unit 10 to add the user message to the positioning message simultaneously and transmit the messages altogether to the central control unit 10 when the mobile tracking unit 22 is sending the positioning message to the central control unit 10. Thereby, the network resources occupied by sending user messages can be saved.

### 3. Registering and Resending Services for Group Messages:

The central control unit 10 registers the positioning messages of all corresponding mobile devices 20 of a group for providing inquiry service to a user of the group and hence the user can inquire the positioning message of the mobile device of a user in the group. Additionally, when a mobile network node changes its address unexpectedly or dynamically, the central control unit 10 will not be able to transmit messages to the mobile devices of the users. At this moment, however, the central control unit 10 will register the messages unsendable to the mobile devices 20. Similar to offline messages in instant messengers, when the mobile device 20 updates its address in mobile network and reconnects to the central control unit 10, the central control unit 10 will send the registered messages to the mobile device 20. Thereby, messages transmitted by the central control unit 10 will not be missed.

4. Location Information Inquiry and Message Forwarding Services within a Group:

The central control unit 10 provides security mechanism for sending messages to mobile devices 30. A mobile device 20 can transmit the location of the mobile device 20 with encryption to an appointed receiving mobile device 20 in the same group. The central control unit 10 provides a plurality of locations of the mobile device 20 to the appointed receiving mobile device 20. However, only one of the locations is valid. The rest of the locations are fake ones for avoiding exposing the correct location of the mobile device 20 to non-group members. Besides, the central control unit 10 according to the present invention can further use message authentication to forward the user message, such as positioning message authentication, sent by the mobile device 20 to another.

The mobile tracking unit 22 is a global positioning unit or a navigation unit, and provides six functions: 1. Registration, inquiry, updating, and application interface for positioning messages of mobile devices 20; 2. Position tracking and application interface for mobile devices 20 and group 30, and management for group attributes and positioning messages; 3. Management for mobile device attributes, group attributes, and positioning messages between mobile devices 20 and the central control unit 10; 4. Exchange and transmission of positioning messages between the mobile tracking unit 24 and the central control unit 10; 5. Message display, graphical interface, map downloading, position marking, and application interface for mobile devices 20 and the group 30; and 6. Advanced display function and application interface for special members in the group 30.

### 1. Registration, Inquiry, Updating, and Application Interface for Positioning Messages of Mobile Devices 20:

Because the mobile tracking unit 22 of the mobile device 20 supports the functions of spontaneous registration and back reporting, when a new mobile device 20 connects to the central control unit 10 via the mobile Internet, the mobile positioning unit 22 requests registration to the central control unit 10 for transmitting information such as mobile device attributes and group attributes. After the central control unit 10 receives the mobile device attributes and the group attributes and authenticates, it will send the corresponding group status and group attributes back to the mobile device 20. When the mobile device 20 of a user in the group has status change or location change, the changed mobile device 20 will send an update request to the central control unit 10 to make the central control unit 10 update. In addition, the central control unit 10 will send confirmation messages to other mobile devices 20 in the same group for making sure that the messages received by the users of the same group are synchronous with the central control unit 10. Moreover, the updating and confirmation described above are performed simultaneously for preventing asynchronism between the messages received by the users in the same group and the message received by the central control unit 10.

Meanwhile, the mobile tracking unit 22 also supports inquiring the statuses and locations of other users in the same group as well as group status. The inquired data is scrambled through the security mechanism of the central control unit 10. That is to say, the central control unit 10 will reply a plurality of locations with only one of them valid. The others are fake ones. In addition, the mobile device 20 can forward user messages to other mobile devices 20 via the central control unit 10.

### 2. Position Tracking and Application Interface for Mobile Devices 20 and Group 30, and Management for Group Attributes and Positioning Messages:

The user can perform information subscription by means of the mobile tracking unit 22 in the mobile device 20. By sending subscription request to the central control unit 10, the user can receive the subscription data transmitted by the central control unit 10 after the central control unit 10 accepts the request.

3. Management for Mobile Device Attributes, Group Attributes, and Positioning Messages between Mobile Devices 20 and the Central Control Unit 10:

When the mobile device 20 joins a group for the first time, it can acquire initial group attributes and attributes of other members in the same group from the central control unit 10. Afterwards, updating and confirmation of messages are performed by caching the registered data by the central control unit 10 and the mobile device 20, respectively. Alternatively, an agent program of the central control unit 10 can be compared asynchronously with the mobile device 20 of the mobile tracking unit 22. If difference exists, updating and confirmation will be performed.

4. Exchange and Transmission of Positioning Messages between the Mobile Tracking Unit 24 and the Central Control Unit 10:

The mobile tracking unit 22 according to the present invention will compare mutually with the central control unit 10 for uploading and downloading data objects in order to exchange and transmit messages.

### 5. Message Display, Graphical Interface, Map Downloading, Position Marking, and Application Interface for Mobile Devices 20 and the Group 30:

The mobile tracking unit 22 according to the present invention provides a graphical interface for the user to perform selections or other operations according to the displayed messages of the graphical interface. A touch panel can be even adopted for direct selection and control. Besides, the mobile tracking unit 22 according to the present invention can further load network maps, such Google Map, for inquiry. The mobile tracking unit 22 according to the present invention can also further record a user's operating customs and thereby display maps in a personalized fashion.

### 6. Advanced Display Function and Application Interface for Special Members in the Group 30:

For members with a special identity, such as the supervisor, in the group, the operating and display methods can be different. The user messages or positioning messages can be hidden on the graphical interface. Alternatively, in a group activity, members in the group 30 can have various displaying method for differentiating sub-groups. In addition, when a member of the group 30 loses the mobile device 20, the lost mobile device 20 is marked in a lost status, and the received messages by the lost mobile device 20 are all fake messages for avoiding data loss. Moreover, when the central control unit 10 transmits positioning messages to the mobile message units of other mobile devices 20 in the group, at least a fake positioning message is further transmitted for enhancing message privacy. The mobile tracking units 22 of the mobile devices 20 can differentiate between the received positioning messages and fake positioning messages according to positioning history data, which includes at least the positioning message received last time by the mobile tracking unit 22.

The mobile message unit 24 provides basic functions such as transmission, receiving, and display of user messages. Delivery of user messages is further divided into simple and rapid message delivery and secure message delivery. In addition, the mobile message unit 24 according to the present invention can configure dynamically. It can also select the simple and rapid message delivery or the secure message delivery, such as adjusting security level, delivery rate, and security and privacy, according to message contents. The user messages include gathering place messages, text messages, voice messages, or multimedia messages. The mobile message unit 24 includes four message delivery modes: 1. Unicast message delivery mode; 2. Multicast message delivery mode; 3. Blanket message delivery mode; and 4. Selective zone message delivery mode.

### 1. Unicast Message Delivery Mode:

In this mode, two mobile devices 20 can know each other's address via the central control unit 10 so that their connection port can connect to each other. Thereby, point-to-point connection is established for exchanging messages directly.

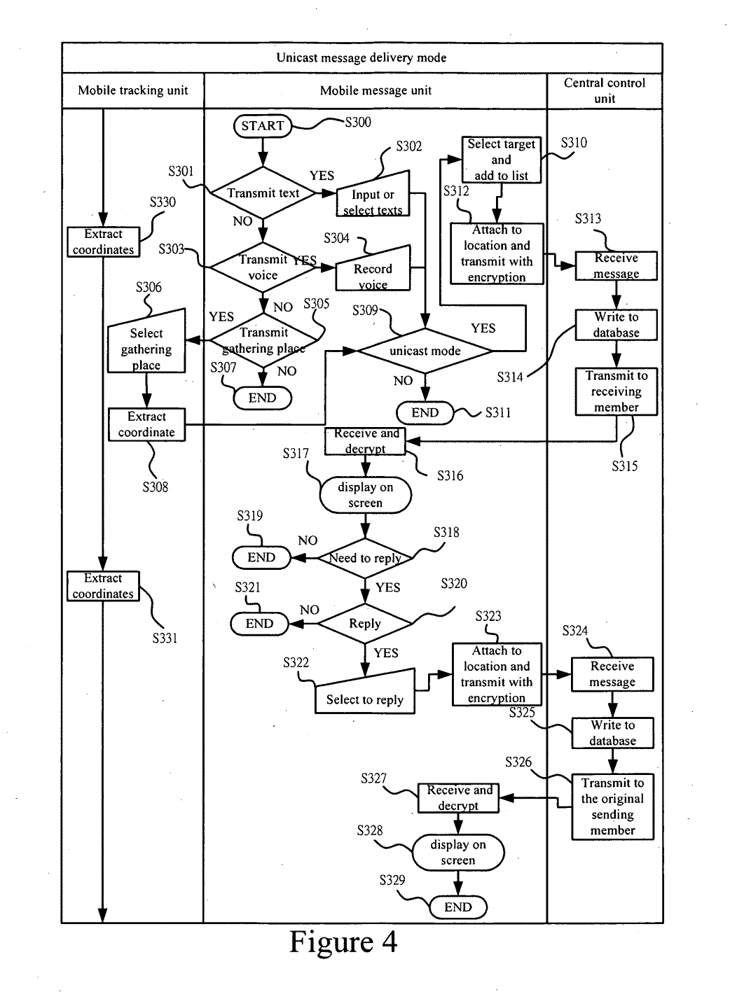

FIG. 4 shows a flowchart of unicast message delivery mode according to an embodiment of the present invention. As shown in the figure, the process of unicast message delivery mode according to the method for mobile group positioning of the present invention is described as follows. According to the present embodiment, text, voice, and gathering place messages are used as examples for user messages. Step S300: Start. Step S301: A first mobile message unit 24 of a first mobile device 20 judges if to transmit text message. If yes, the step S302 is executed; if not, the step S303 is executed. Step S302: The user inputs texts or selects template texts via the first mobile message unit 24. Step S303: The first mobile message unit judges if to transmit voice message. If yes, the step S304 is executed; if not, the step S305 is executed. Step S304: The first mobile message unit 24 records the voice message to be transmitted. Step S305: The first mobile message unit 24 judges if to transmit gathering place. If yes, the step S306 is executed; if not, the step S307 is executed. Step S306: Select a gathering place on the map displayed on the first mobile device 20 according to the first mobile tracking unit 22. Step S307: End. Step S308: The first mobile tracking unit 22 calculates corresponding coordinates according to the gathering place selected in the step S306 and transmits the coordinates to the first mobile message unit 24. Step S309: The mobile message unit 24 judges if to select the unicast message delivery mode to transmit a user message produced by combining the message according to the step S302 or S304 and the gathering place. If yes, the step S310 is executed; if not, the step S311 is executed. Step S310: The first mobile message unit 24 adds a delivery target selected by the user to the delivery list. Step S311: End.

Step S312: The first mobile message unit 24 adds the user message produced in the step S309 to the positioning message produced in the step S330 by the first mobile tracking unit 22 and transmits to the central control unit 10. The first mobile message unit 24 further encrypts the positioning message including the user message and transmits to the central control unit 10. Step S313: The central control unit 10 receives the message transmitted by the first mobile message unit 24 in the step S312. Step S314: The central control unit 10 writes the user message and positioning message received according to the step S313 to the database. Step S315: The central control unit 10 transmits the user message and positioning message received in the step S313 to a second mobile message unit 24 of a receiving member assigned in the delivery list produced according to the step S310. The central control unit 10 further encrypts the message transmitting to the second mobile message unit 24. Step S316: The second mobile message unit 24 receives the user message and positioning message transmitted by the central control unit 10 in the step S315 and decrypts. The mobile message unit 24 judges the validity of the user message according to the positioning message transmitted by the central control unit 10 for reading the correct user message. Step S317: The second mobile message unit 24 displays the message decrypted according to the step S316 on the display. Step S318: The second mobile message unit 24 judges if to reply the message displayed according to the step S317. If yes, the step S320 is executed; if not, the step S319 is executed. Step S319: End. Step S320: The second mobile message unit 24 judges if to reply. If not, the step S321 is executed; if yes, the step S322 is executed. Step S321: End. Step S322: The mobile message unit 24 selects to reply according to the user's request, and produces a reply message.

Step S323: The second mobile message unit 24 adds the reply message produced in the step S322 to the positioning message produced in the step S331 by the second mobile tracking unit 22. Step S324: The central control unit 10 receives the message transmitted by the second mobile message unit in the step S323. Step S325: The central control unit writes the message received in the step S324 to the database 42. Step S326: The central control unit 10 transmits the message received in the step S324 to the first mobile message unit 24. Step S327: The first mobile message unit 24 receives the message transmitted by the central control unit 10 in the step S326 and decrypts. The mobile message unit 24 judges the validity of the user message according to the positioning message transmitted by the central control unit 10 for reading the correct user message. Step S328: The first mobile message unit 24 displays the message decrypted in the step S327. Step S329: End.

Additionally, step S330: The mobile tracking unit 22 extracts the geographical location of the mobile device 20 to which the mobile tracking unit 22 belongs for producing a first positioning message. Step S331: The mobile tracking unit 22 extracts the geographical location of the mobile device 20 to which the mobile tracking unit 22 belongs for producing a second positioning message.

### 2. Multicast Message Delivery Mode:

When the mobile devices 20 in the same group are in the same network segment, the multicast message delivery mode can be used to deliver messages. In other word, this is a message delivery method within a group. Members outside of the group cannot get the group-delivered message. The mobile devices 20 confirm if multicast mode is allowable according to the group attributes provides by the central control unit 10.

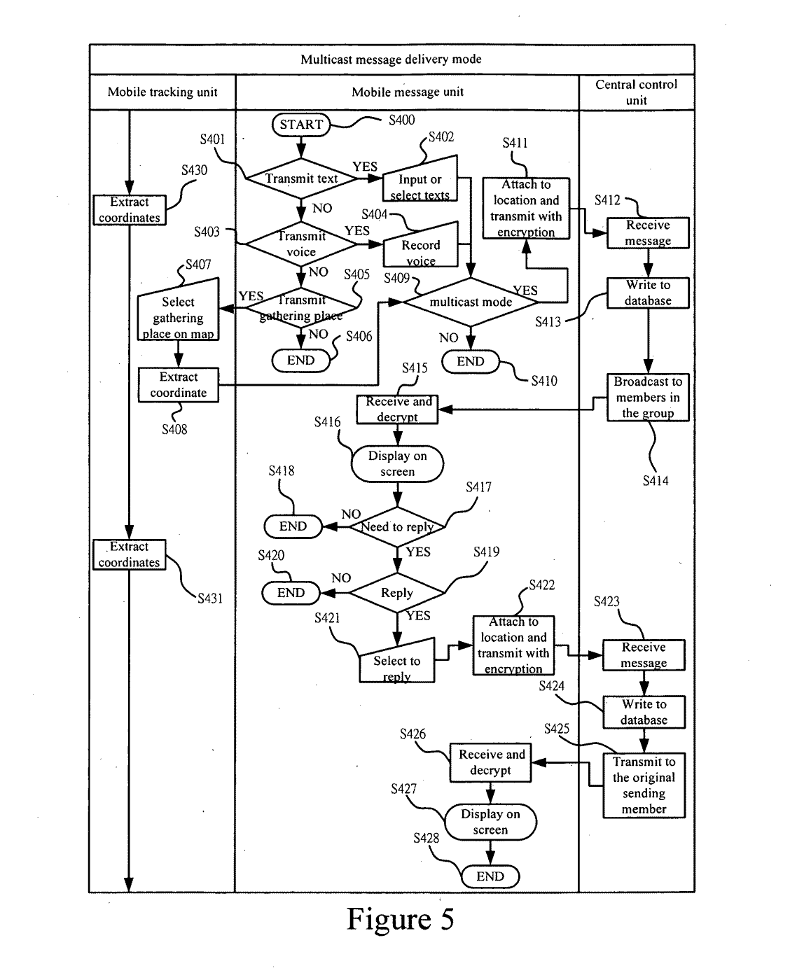

FIG. 5 shows a flowchart of multicast message delivery mode according to an embodiment of the present invention. As shown in the figure, the process of multicast message delivery mode according to the method for mobile group positioning of the present invention is described as follows. According to the present embodiment, text, voice, and gathering place messages are used as examples for user messages. Step S400: Start. Step S401: A mobile message unit 24 of a mobile device 20 judges if to transmit text message. If yes, the step S402 is executed; if not, the step S403 is executed. Step S402: The user inputs texts or selects template texts via the mobile message unit 24. Step S403: The mobile message unit judges if to transmit voice message. If yes, the step S404 is executed; if not, the step S405 is executed. Step S404: The mobile message unit 24 records the voice message to be transmitted. Step S405: The mobile message unit 24 judges if to transmit gathering place. If yes, the step S406 is executed; if not, the step S407 is executed. Step S406: Select a gathering place on the map displayed on the mobile device 20 according to the mobile tracking unit 22. Step S407: End. Step S408: The mobile tracking unit 22 calculates corresponding coordinates according to the gathering place selected in the step S406 and transmits the coordinates to the mobile message unit 24. Step S409: The mobile message unit 24 judges if to select the multicast message delivery mode to transmit a user message produced by combining the message according to the step S402 or S404 and the gathering place. If not, the step S410 is executed; if yes, the step S411 is executed. Step S410: End. Step S411: The mobile message unit 24 adds the user message produced according to the step S409 to the positioning message produced by the mobile tracking unit 22 in the step S430 and transmits to the central control unit 10. The mobile message unit 24 further encrypts the positioning message including the user message and transmits to the central control unit 10.

Step S412: The central control unit 10 receives the message transmitted by the mobile message unit 24 in the step S411. Step S413: The central control unit 10 writes the user message and positioning message received according to the step S412 to the database. Step S414: The central control unit 10 transmits the user message and positioning message received in the step S412 to the mobile message units 24 of the other members in the group of the mobile device 20. The central control unit 10 further encrypts the message transmitting to the mobile message units 24. Besides, when the central control unit 10 transmits the positioning message to the mobile message units 24 of the other mobile devices 20 of the group 30, a fake positioning message is further transmitted for enhancing message privacy. The mobile tracking units 22 of the mobile devices 20 can differentiate between the received positioning messages and fake positioning messages according to positioning history data, which includes at least the positioning message received last time by the mobile tracking unit 22. Step S415: The mobile message units 24 of the other members in the group receive the user message and positioning message transmitted by the central control unit 10 in the step S414 and decrypts. The mobile message units 24 judge the validity of the user message according to the positioning message transmitted by the central control unit 10 for reading the correct user message. Step S416: The mobile message units 24 of the other members in the group display the message decrypted according to the step S415 on the display. Step S417: A mobile message unit 24 having received the message judges if to reply the message displayed according to the step S416. If yes, the step S419 is executed; if not, the step S418 is executed. Step S418: End. Step S419: The mobile message unit 24 having received the message judges if to reply. If not, the step S420 is executed; if yes, the step S421 is executed. Step S420: End. Step S421: The mobile message unit 24 selects to reply according to the user's request, and produces a reply message.

Step S422: The mobile message unit 24 having received the message adds the reply message produced in the step S421 to the positioning message produced in the step S431 by the mobile tracking unit 22. Step S423: The central control unit 10 receives the message transmitted by the mobile message unit in the step S422. Step S424: The central control unit writes the message received in the step S423 to the database 42. Step S425: The central control unit 10 transmits the message received in the step S423 to the other members in the group. Step S426: The mobile message units 24 of the other members in the group receive the message transmitted by the central control unit 10 in the step S425 and decrypt. The mobile message, units 24 judge the validity of the user message according to the positioning message transmitted by the central control unit 10 for reading the correct user message. Step S427: The mobile message units 24 of the other members in the group display the message decrypted in the step S426. Step S428: End.

Additionally, step S430: The mobile tracking unit 22 extracts the geographical location of the mobile device 20 to which the mobile tracking unit 22 belongs for producing a first positioning message. Step S431: The mobile tracking unit 22 extracts the geographical location of the mobile device 20 to which the mobile tracking unit 22 belongs for producing a second positioning message.

### 3. Blanket Message Delivery Mode:

The present mode provides any mobile device 20 in the group with the capability of delivering messages in a different network segment to the mobile devices 20 of the same group in the blanket network domain. The difference between the present mode and the multicast mode is that, according to the present mode, the mobile device 20 delivering messages is connected to the mobile devices of the same group in the blanket network domain for delivering the messages synchronously to the mobile devices 20 of the same group in the blanket network domain. In order to reduce loads of blanket messages, a supervisor is disposed in the group and the supervisor's mobile device 20 is responsible for delivering blanket messages. However, when an emergence message is included in the message tag, the supervisor's mobile device 20 will drive the mobile message unit 24 to transmit the message first.

### 4. Selective Zone Message Delivery Mode:

The delivery zone of the present mode is smaller relative to that of the blanket message delivery mode described above. Namely, the present mode delivers messages for a single network segment or multiple network segments, and thereby is a strategic message delivery mode. The mobile message unit 24 which transmits messages tracks zone changes of message delivery according to the target message provided by the central control unit 10.

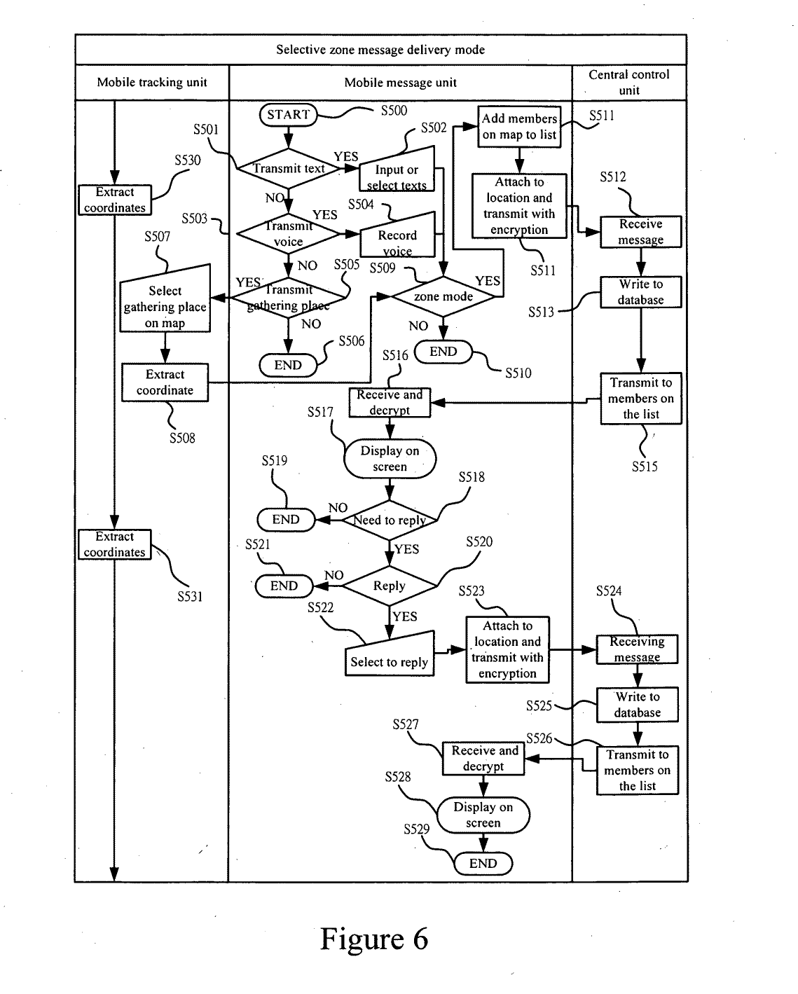

FIG. 6 shows a flowchart of selective zone message delivery mode according to an embodiment of the present invention. As shown in the figure, the process of selective zone message delivery mode according to the method for mobile group positioning of the present invention is described as follows. According to the present embodiment, text, voice, and gathering place messages are used as examples for user messages.

Step S500: Start. Step S501: A first mobile message unit 24 of a first mobile device 20 judges if to transmit text message. If yes, the step S502 is executed; if not, the step S503 is executed. Step S502: The user inputs texts or selects template texts via the first mobile message unit 24. Step S503: The first mobile message unit 24 judges if to transmit voice message. If yes, the step S504 is executed; if not, the step S505 is executed. Step S504: The first mobile message unit 24 records the voice message to be transmitted. Step S505: The first mobile message unit 24 judges if to transmit gathering place. If not, the step S506 is executed; if yes, the step S507 is executed. Step S506: End. Step S507: Select a gathering place on the map displayed on the first mobile device 20 according to the first mobile tracking unit 22. Step S508: The first mobile tracking unit 22 calculates corresponding coordinates according to the gathering place selected in the step S506 and transmits the coordinates to the first mobile message unit 24. Step S509: The mobile message unit 24 judges if to select the selective zone message delivery mode to transmit a user message produced by combining the message according to the step S502 or S504 and the gathering place. If yes, the step S510 is executed; if not, the step S511 is executed. Step S510: End. Step S511: The first mobile message unit 24 selects at least a zone to deliver message to according to user's request. If the user's request is all zones, then blanket delivery is selected. Meanwhile, the first mobile message unit 24 selects members in the zone according to user's request and adds them to a delivery list.

Step S512: The first mobile message unit 24 adds the user message produced in the step S509 to the positioning message produced in the step S530 by the first mobile tracking unit 22 and transmits to the central control unit 10. The first mobile message unit 24 further encrypts the positioning message including the user message and transmits to the central control unit 10. Step S513: The central control unit 10 receives the message transmitted by the first mobile message unit 24 in the step S512. Step S514: The central control unit 10 writes the user message and positioning message received according to the step S513 to the database. Step S515: The central control unit 10 transmits the user message and positioning message received in the step S513 to a second mobile message unit 24 assigned in the delivery list produced according to the step S511. The central control unit 10 further encrypts the message transmitting to the second mobile message unit 24. Step S516: The second mobile message unit 24 receives the user message and positioning message transmitted by the central control unit 10 in the step S515 and decrypts. The mobile message unit 24 judges the validity of the user message according to the positioning message transmitted by the central control unit 10 for reading the correct user message. Step S517: The second mobile message unit 24 displays the message decrypted according to the step S516 on the display. Step S518: The second mobile message unit 24 judges if to reply the message displayed according to the step S517. If yes, the step S520 is executed; if not, the step S519 is executed. Step S519: End. Step S520: The second mobile message unit 24 judges if to reply. If not, the step S521 is executed; if yes, the step S522 is executed. Step S521: End. Step S522: The mobile message unit 24 selects to reply according to the user's request, and produces a reply message.

Step S523: The second mobile message unit 24 adds the reply message produced in the step S522 to the positioning message produced in the step S531 by the second mobile tracking unit 22. Step S524: The central control unit 10 receives the message transmitted by the second mobile message unit in the step S523. Step S525: The central control unit writes the message received in the step S524 to the database 42. Step S526: The central control unit 10 transmits the message received in the step S524 to the first mobile message unit 24 and the other members in the delivery list. Step S527: The first mobile message unit 24 and the mobile message units 24 of the other members in the delivery list receive the message transmitted by the central control unit 10 in the step S526 and decrypts. The mobile message units 24 judge the validity of the user message according to the positioning message transmitted by the central control unit 10 for reading the correct user message. Step S528: The first mobile message unit 24 displays the message decrypted in the step S527. Step S529: End. Besides, when the central control unit 10 transmits the positioning message to the mobile message units 24 of the other mobile devices 20 of the group, a fake positioning message is further transmitted for enhancing message privacy. The mobile tracking units 22 of the mobile devices 20 can differentiate between the received positioning messages and fake positioning messages according to positioning history data, which includes at least the positioning message received last time by the mobile tracking unit 22.

Additionally, step S530: The mobile tracking unit 22 extracts the geographical location of the mobile device 20 to which the mobile tracking unit 22 belongs for producing a first positioning message. Step S531: The mobile tracking unit 22 extracts the geographical location of the mobile device 20 to which the mobile tracking unit 22 belongs for producing a second positioning message.

Referring back to FIG. 1, the present invention further includes a managerial terminal device 40 and a database 42. The database is connected to the managerial terminal device 40 and the central control unit 10. The managerial terminal device 40 manages the central control unit 10 and the database 42. The central control unit 10 stores the positioning messages in the database 42, and tracks and updates the positioning messages stored in the database 42. The managerial terminal device 40 is a personal computer, a portable computer, or a server. Besides, the positioning messages are encrypted messages.

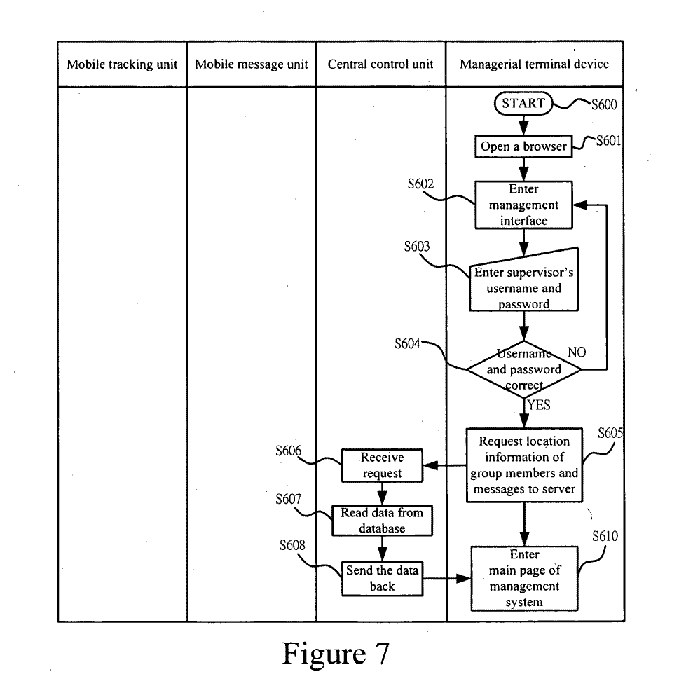

FIG. 7 shows a flowchart of the process at the managerial terminal according to an embodiment of the present invention. As shown in he figure, the managerial terminal device 40 according to the present invention can manage related information of the group 30. Before the managerial terminal device 40 processes data, it needs to request the related data of the group 30 to the central control unit 10 as shown in the steps S600 to S610. It can further enter the management interface for non-message related management of the group 30. As shown in the step S600, the managerial terminal device 40 starts the process. As shown in the step S601, the managerial terminal device 40 open s a browser according to the supervisor's request. As shown in the step S602, the managerial terminal device 40 enters the management interface via the browser. As shown in the step S603, the supervisor enters his username and password via the managerial terminal device 40. As shown in the step S604, the supervisor's identity is judged to be correct or not. If yes, the step S605 is executed; if not, the step S602 is executed. As shown in the step S605, the managerial terminal device 40 submits a request for data to the central control unit 10. As shown in the step S606, the central control unit 10 receives the request submitted by the managerial terminal device 40. As shown in the step S607, the central control unit 10 reads the corresponding message data in the database according to the submitted request by the managerial terminal device 40 in the step S605. As shown in the step S608, the central control unit 10 transmits the message data read in the step S607 to the managerial terminal device 40. As shown in the step S610, the managerial terminal device. 40 enters the main page of the management system.

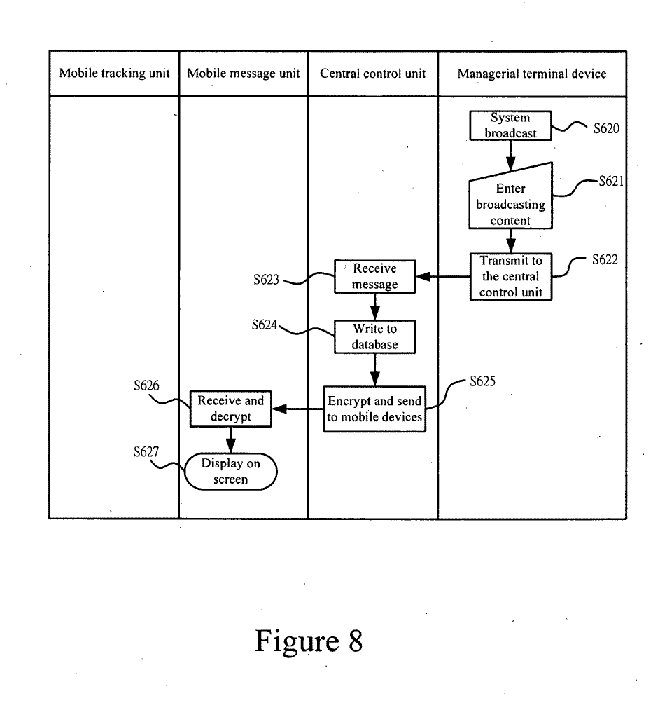

In addition, the managerial terminal device 40 further broadcasts to the members of the group 30 as shown in FIG. 8. As shown in the step S620, the managerial terminal device 40 executes a system broadcast program. As shown in the step S621, the supervisor enters the broadcasting content via the managerial terminal device 40. As shown in the step S622, the managerial terminal device 40 transmits the broadcasting content entered in the step S621 to the central control unit 10. As shown in the step S623, the central control unit 10 receives the content transmitted by the managerial terminal device 40. As shown in the step S624, the central control unit 10 writes the message received in the step S623 to the database 42. As shown in the step S625, the central control unit 10 encrypts and transmits the message received in the step S623 to the mobile devices 20 connecting to the central control unit 10 or the members of at least a group. As shown in the step S626, the mobile devices 20 receive and decrypt the system broadcasting content by the central control unit 10. As shown in the step S627, the mobile devices 20 receiving the message display the received and decrypted system broadcasting content in the step S626.

To sum up, the system and method for mobile group positioning use mobile tracking units of mobile devices to acquire positioning messages, and use mobile message units to combine the positioning messages and user messages and transmit to the central control unit. Thereby, when the mobile devices are transmitting the user messages, the user messages are combined with the positioning messages and are transmitted altogether to a receiving mobile device. In this way, no extra network resources and power are needed for transmitting the user messages.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A system for mobile group positioning, applied to a plurality of mobile devices of a group, and comprising:
a central control system, connecting to said plurality of mobile devices;
a plurality of mobile tracking units, disposed in said plurality of mobile devices, respectively, producing a plurality of positioning messages according to the geographical locations of said plurality of mobile devices, respectively, and transmitting said plurality of positioning messages to said central control unit; and
a plurality of mobile message units, disposed in said plurality of mobile devices and corresponding to said plurality of mobile tracking units, respectively, used for adding a user message to said corresponding plurality of positioning messages, respectively, and transmitting to said central control unit, and said central control unit transmitting said positioning messages including said user message to said mobile message unit of one of said plurality of mobile devices in said group.

2. The system for mobile group positioning of claim 1, and further comprising:
a managerial terminal device, managing said central control unit; and
a database, connecting to said central control unit and said managerial terminal device, said central control unit storing said plurality of positioning messages and updating said database, and said managerial terminal device managing said database.

3. The system for mobile group positioning of claim 2, wherein said managerial terminal device is a personal computer, a portable computer, or a server.

4. The system for mobile group positioning of claim 1, wherein said user message includes a gathering location message, a voice message, a text message, or combination of said three.

5. The system for mobile group positioning of claim 1, wherein said mobile tracking unit is a global positioning unit or a navigation unit.

6. The system for mobile group positioning of claim 1, wherein when one of said plurality of mobile devices builds said group, said mobile message unit of said mobile device to build said group produces a group-building message and transmits to said central control unit, and said central control unit builds said group according to said group-building message and produces a group code.

7. The system for mobile group positioning of claim 1, wherein when one of said plurality of mobile devices joins said group, said mobile message unit of said mobile device to join said group adds a group code produced by said central control unit to said positioning message and transmits to said central control unit; and when said central control unit confirms the existence of said group according said group code, said central control unit adds said mobile device to said group and transmits a corresponding system message to said mobile device.

8. The system for mobile group positioning of claim 1, wherein said mobile message unit of said mobile device further encrypts said positioning message and said user message for transmitting to said central control unit.

9. The system for mobile group positioning of claim 1, wherein said central control unit further encrypts said positioning message and said user message for transmitting to said mobile message unit of one of said plurality of mobile devices in said group.

10. The system for mobile group positioning of claim 1, wherein said mobile message unit of one of said plurality of mobile devices in said group judges if the user is valid or not according to said positioning message transmitted by said central control unit; and when said mobile message unit confirms validity of said user message, said mobile message unit reads said user message.

11. The system for mobile group positioning of claim 1, wherein said mobile message unit of one of said plurality of mobile devices in said group receives said user message and said positioning message and decrypts.

12. The system for mobile group positioning of claim 1, wherein when said central control unit transmits said positioning message to one of said plurality of mobile devices, a fake positioning message is further transmitted.

13. The system for mobile group positioning of claim 12, wherein said mobile tracking unit of said mobile device receiving said fake positioning message differentiating between said positioning message and said fake positioning message according to positioning history data.

14. The system for mobile group positioning of claim 1, wherein the message delivery modes of said mobile message unit include the unicast message delivery mode, the multicast message delivery mode, the blanket message delivery mode, and the selective zone message delivery mode.

15. The system for mobile group positioning of claim 1, wherein said mobile device is a personal computer, a portable computer, or a server.

16. A method for mobile group positioning, applied to a plurality of mobile devices in a group, and comprising steps of:
producing a plurality of positioning messages according a plurality of geographical locations of said plurality of mobile devices;
one of said mobile devices adding a user message to said corresponding positioning message;
transmitting said positioning message including said user message to a central control unit; and
said central control unit transmitting said positioning message including said user message to one of said plurality of mobile devices in said group.

17. The method for mobile group positioning of claim 16, and further comprising a step of tracking and updating said plurality of positioning messages.

18. The method for mobile group positioning of claim 16, wherein the step of transmitting said positioning message including said user message to said central control unit includes encrypting said positioning message including said user message.

19. The method for mobile group positioning of claim 18, wherein after the step of said central control unit transmitting said positioning message including said user message to one of said plurality of mobile devices in said group, a step is further included for receiving and decrypting said positioning message including said user message.

20. The method for mobile group positioning of claim 16, wherein after the step of said central control unit transmitting said positioning message including said user message to one of said plurality of mobile devices in said group, a step is further included for confirming the validity of said user message according to said positioning message and reading said user message if said user message is valid.

21. The method for mobile group positioning of claim 16, wherein in the step of said central control unit transmitting said positioning message including said user message to one of said plurality of mobile devices in said group, said central control unit further transmits at least a fake positioning message to one of said plurality of mobile devices in said group for said mobile device receiving said fake positioning message differentiating between said positioning message and said fake positioning message according positioning history data.

22. The method for mobile group positioning of claim 16, wherein in the step of said central control unit transmitting said positioning message including said user message to one of said plurality of mobile devices in said group, the unicast message delivery mode, the multicast message delivery mode, the blanket message delivery mode, or the selective zone message delivery mode are used.

23. The method for mobile group positioning of claim 16, wherein said mobile device is a personal computer, a portable computer, or a server.

24. The method for mobile group positioning of claim 16, wherein the step of said central control unit transmitting said positioning message including said user message to one of said plurality of mobile devices in said group further encrypts the positioning message.

25. The method for mobile group positioning of claim 16, wherein said user message includes a gathering location message, a voice message, a text message, or combination of said three.
